(19) United States
(12) Patent Application Publication
(10) Pub. No.: US 2006/0216557 A1
(43) Pub. Date: Sep. 28, 2006

(54) Fuel cell system and method of operating fuel cell system

(76) Inventors: Hirohisa Miyamoto, Kamakura-shi (JP); Nobuo Shibuya, Hiratsuka-shi (JP); Hideyuki Oozu, Yokohama-shi (JP); Norihiro Tomimatsu, Mitaka-shi (JP); Hiroyasu Sumino, Tokyo (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/378,334

(22) Filed: Mar. 20, 2006

(30) Foreign Application Priority Data
Mar. 24, 2005 (JP) 2005-085980

(51) Int. Cl. H01M 8/04

(52) U.S. Cl. 429/22; 429/30; 429/13

(57) ABSTRACT

A fuel cell system includes a cathode, an anode, a fuel supply unit configured to supply a fuel containing methanol and water to the anode, a methanol supply unit configured to supply methanol to the fuel, a sensor which measures a methanol concentration of the fuel, a current measuring unit configured to measure a current flowing between the cathode and the anode, a concentration adjusting unit and a correction unit. The concentration adjusting unit is configured to adjust the methanol concentration of the fuel by controlling the methanol supply unit by using an output value of the sensor. The correction unit is configured to correct a data of a relation between the methanol concentration of the fuel and the output value of the sensor, using an output of the current measuring unit.

### CROSS-REFERENCE TO RELATED APPLICATIONS

This application is based upon and claims the benefit of priority from prior Japanese Patent Application No. 2005-085980, filed Mar. 24, 2005, the entire contents of which are incorporated herein by reference.

### BACKGROUND OF THE INVENTION

1. Field of the Invention

The present invention relates to a fuel cell system, and a method of operating the fuel cell system. The invention is preferably applied in a fuel cell system using a fuel containing methanol and water.

2. Description of the Related Art

Development of small fuel cells for use in a small information terminal such as a personal digital assistant and portable appliances has been promoted recently. In these fuel cells, liquid fuels such as methanol and ethanol are used as fuels from the viewpoint of ease of fuel refilling and simple structure of a fuel tank. To reduce the size of a fuel cell system, it is preferred to use a fuel cell system capable of supplying a fuel directly to a power generating part without reforming a liquid fuel to hydrogen.

A conventional fuel cell system includes a mixing tank. The mixing tank is to supply a fuel containing methanol and water to a stack cell. The methanol concentration of the mixing tank is adjusted by, for example, supplying the methanol contained in a fuel cartridge into the mixing tank by using a pump. The methanol concentration is detected by using a concentration sensor (see, for example, Jpn. Pat. Appln. KOKAI Publication No. 2004-265787).

As the concentration sensor, one comprising, for example, an ultrasonic transmitter, an ultrasonic receiver, and a dielectric constant measuring unit is known. The methanol concentration is measured on the basis of the speed of an ultrasonic wave transmitted from the ultrasonic transmitter and the dielectric constant of the fuel (see Jpn. Pat. Appln. KOKAI Publication No. 2005-30949).

### BRIEF SUMMARY OF THE INVENTION

According to a first aspect of the present invention, there is provided a fuel cell system comprising:

a polymer electrolyte membrane;

a cathode provided at one side of the polymer electrolyte membrane;

an anode provided at the other side of the polymer electrolyte membrane;

an oxygen supply unit configured to supply oxygen to the cathode;

a fuel supply unit configured to supply a fuel containing methanol and water to the anode;

a methanol supply unit configured to supply methanol to the fuel;

a sensor which measures a methanol concentration of the fuel;

a current measuring unit configured to measure a current flowing between the cathode and the anode;

a concentration adjusting unit configured to adjust the methanol concentration of the fuel by controlling the methanol supply unit by using an output value of the sensor; and

a correction unit configured to correct a data of a relation between the methanol concentration of the fuel and the output value of the sensor, using an output of the current measuring unit.

According to a second aspect of the present invention, there is provided a method of operating a fuel cell system comprising:

a polymer electrolyte membrane;

a cathode provided at one side of the polymer electrolyte membrane;

an anode provided at the other side of the polymer electrolyte membrane;

an oxygen supply unit configured to supply oxygen to the cathode;

a fuel supply unit configured to supply a fuel containing methanol and water to the anode;

a methanol supply unit configured to supply methanol to the fuel;

a sensor which measures a methanol concentration of the fuel;

a current measuring unit configured to measure a current flowing between the cathode and the anode; and

a concentration adjusting unit configured to adjust the methanol concentration of the fuel by controlling the methanol supply unit by using an output value of the sensor, the method comprising:

stopping both the methanol supply unit and the concentration adjusting unit; and

correcting a data of a relation between the methanol concentration of the fuel and the output value of the sensor, using an output of the current measuring unit.

### BRIEF DESCRIPTION OF THE SEVERAL VIEWS OF THE DRAWING

FIG. 1 is a diagram showing a fuel cell system according to a first embodiment of the present invention;

FIG. 2 is a graph showing the principle of the correction in the fuel cell system according to the first embodiment of the invention;

FIG. 3 is a flowchart showing a method of operating a fuel cell system according to a second embodiment of the invention;

FIG. 4 is a flowchart showing the method of operating the fuel cell system according to the second embodiment of the invention;

FIG. 5 is a flowchart showing the method of operating the fuel cell system according to the second embodiment of the invention; and

FIG. 6 is a flowchart showing the method of operating the fuel cell system according to the second embodiment of the invention.

### DETAILED DESCRIPTION OF THE INVENTION

When the concentration sensor disclosed in Jpn. Pat. Appln. KOKAI Publication No. 2005-30949 was used in a fuel cell system, the following problems occurred. Speed of the ultrasonic wave transmitted from the ultrasonic transmitter and the dielectric constant of the fuel depends on the temperature. Therefore, when the fuel temperature is changed, the fuel cell system cannot measure the concentration of the fuel correctly. A temperature sensor may be provided near the concentration sensor, the measured value by the concentration sensor is corrected, and the corrected value may be obtained as fuel concentration. However, since a fuel cell system is changed in a calorific value of a stack cell when power generation fluctuates, an error due to surrounding thermal environmental changes may occur in correction.

When the fuel cell system is used for a long period, the zero point adjustment of the concentration sensor may gradually deviated.

According to a fuel cell system according to the embodiments of the invention described below and a method of operating the fuel cell system, the methanol concentration of a fuel can be measured more accurately.

### First Embodiment

FIG. 1 is a diagram showing a fuel cell system according to a first embodiment of the invention.

A fuel cell 1 provided in the fuel cell system receives a fuel and an oxidizer including oxygen, and generates electric power by using them. As the fuel, for example, a diluted fuel such as an aqueous methanol solution may be used. The aqueous methanol solution may contain components other than methanol and water. On the other hand, for example, air may be used as the oxidizer.

The fuel cell 1 will be specifically described below. The fuel cell 1 comprises a polymer electrolyte membrane 1a, a cathode 1b formed at one side of the polymer electrolyte membrane 1a, and an anode 1c formed at the opposite side of the polymer electrolyte membrane 1a. A laminated body composed of the polymer electrolyte membrane 1a, the cathode 1b and the anode 1c is called a membrane electrode assembly.

A membrane capable of passing hydrogen ions and not passing electrons is used as the polymer electrolyte membrane 1a. Such a membrane is, for example, NAFION (registered trademark) membrane. The cathode 1b includes a conductive layer (not shown) containing a catalyst, and a gas diffusion layer (not shown) to be laminated on the conductive layer. A passage plate 1d is opposite to the cathode 1b. The anode 1c includes a conductive layer (not shown) containing a catalyst, and a gas diffusion layer (not shown) to be laminated on the conductive layer. A passage plate 1e is opposite to the anode 1c.

Example of the usable catalyst of the cathode 1b include carbon fibers carrying a platinum catalyst. On the other hand, examples of the usable catalyst of the anode 1c include carbon fibers carrying a platinum/ruthenium alloy catalyst. In both the cathode 1b and the anode 1c, the side of the conductive layer containing a catalyst is opposite to the polymer electrolyte membrane 1a. In the fuel cell having such a configuration, power is generated by supplying oxygen such as air to the cathode 1b, and a diluted fuel to the anode 1c.

Carbon paper may be used as the gas diffusion layer. The gas diffusion layer is provided so as to supply a diluted fuel and oxygen uniformly to the conductive layer containing a catalyst as much as possible. The gas diffusion layer also plays the role of discharging carbon dioxide, steam and other byproducts generated by power generation uniformly from the conductive layer containing a catalyst.

The passage plates 1d, 1e are provided for supplying a diluted fuel and oxygen to the gas diffusion layer. The passage plates 1d, 1e also play the role of taking out the electric power generated by the fuel cell 1 to outside. The passage plates 1d, 1e may be, for example, carbon plates having serpentine grooves. The number of membrane electrode assemblies may be changed freely depending on the desired power generation capacity, and may be one or a plurality. A fuel cell of high voltage can be realized by connecting a plurality of membrane electrode assemblies in series.

A diluted fuel 2a is stored in a circulating fuel tank 2. The fuel cell 1 and circulating fuel tank 2 are connected by piping 4 such that the diluted fuel may be circulated. The piping 4 includes piping 4a for supplying the diluted fuel 2a in the circulating fuel tank 2 into the anode 1c of the fuel cell 1, and piping 4b for returning the diluted fuel 2a discharged from the anode 1c of the fuel cell 1 into the circulating fuel tank 2. The piping 4a is provided with a circulating pump 3 for circulating the diluted fuel. By driving the circulating pump 3, the diluted fuel 2a in the circulating fuel tank 2 is supplied to the anode 1c of the fuel cell 1 through the piping 4a, and at least part of the excessive diluted fuel 2a discharged from the anode 1c is further sent into the circulating fuel tank 2 through the piping 4b. The diluted fuel 2a returned to the circulating fuel tank 2 is supplied again to the fuel cell 1 through the piping 4a, and the unreacted fuel contained in the diluted fuel and water are used to generate power. Thus, the fuel supply unit include the circulating fuel tank 2, the circulating pump 3, the piping 4, and peripheral members such as control members (not shown) of the circulating pump 3.

In the midst of a circulating route formed by the circulating fuel tank 2 and the piping 4, a concentrated fuel pump 6 is connected. A concentrated fuel tank 5 is connected to the concentrated fuel pump 6. A concentrated fuel 5a containing methanol of high concentration is stored in the concentrated fuel tank 5. The concentrated fuel 5a in the concentrated fuel tank 5 is supplied into the circulating fuel tank 2 by the concentrated fuel pump 6, whereby methanol can be properly added to the diluted fuel 2a. Thus, the methanol supply unit includes the concentrated fuel tank 5, the concentrated fuel pump 6, and peripheral members such as a check valve (not shown). The methanol supply unit is provided to heighten the methanol concentration in the diluted fuel in the circulating route.

The fuel cell 1 comprises not only the above fuel supply unit for supplying the diluted fuel, but also oxygen supply unit for supplying oxygen. Piping 7 is provided for supplying oxygen to the cathode 1b of the fuel cell 1. An air feed pump 8 for feeding air into the fuel cell 1 is provided to the piping 7. Thus, the oxygen supply unit includes the piping 7, the air feed pump 8, and peripheral members such as control members (not shown) of the air feed pump 8.

Exhaust components are discharged from the fuel cell system 1 through a piping 9. The exhaust components include steam and other byproduct gases discharged from the cathode 1b, and carbon dioxide and other byproduct gases discharged from the anode 1c.

To release the heat generated in the fuel cell system 1 to outside, the piping 4 and the piping 9 are cooled by a cooling unit 10 such as a fan. The cooling unit 10 is also used for cooling a condenser 11. Part of the exhaust components described above, in particular, part of the steam condenses to water in the condenser 11, and produced water is returned to a water tank 12. The water returned to the water tank 12 is used again for diluting methanol. Water in the water tank 12 is sent to the circulating fuel tank 2 as required through a piping 13 and a water recovery pump 14, so that the methanol concentration of the diluted fuel in the circulating route is adjusted to a lower value.

Part of the diluted fuel in the circulating route is bypassed to a concentration sensor 15. The methanol concentration of the bypassed diluted fuel is measured by the concentration sensor 15. The concentration sensor 15 may be any known sensor capable of measuring the propagation speed of an ultrasonic wave, boiling point, dielectric constant, and refractive index of light. The concentration sensor 15 outputs a signal according to the concentration of the diluted fuel to a correction unit 16 described below. For example, in the case of an ultrasonic oscillator sensor which measures propagation speed of an ultrasonic wave, propagation time of an ultrasonic wave over a preset distance is converted into a voltage as an analog signal, and the analog signal is output.

The electric power generated by the fuel cell 1 is sent into a load 18 or a lithium ion battery (LIB) 19 as described below, by way of an ammeter 17 (current measuring unit) 17 provided in the correction unit 16. The ammeter 17 measures a current flowing between the cathode 1b and the anode 1c by way of the load 18 or LIB 19.

The correction unit 16 corrects (calibrates) the relation between an output value from the concentration sensor 15 and the methanol concentration of the diluted fuel determined from the output value of the concentration sensor 15, on the basis of the output of the ammeter 17, that is, the current flowing between the cathode 1b and the anode 1c.

The correction unit 16 receives a signal according to the output value from the concentration sensor 15, for example, an analog signal described above. The correction unit 16 stores data about the relation of this signal and the methanol concentration of the diluted fuel. The relation between this signal and the methanol concentration of the diluted fuel is, for example, database of functions and tables approximated in each operating condition of the fuel cell 1.

A current storage unit 19 is connected to the load 18. The current storage unit 19 complements the electric power flowing from the fuel cell 1 to the load 18 while the correction unit 16 is correcting the relation between the output value from the concentration sensor 15 and the methanol concentration of the diluted fuel determined from the output value of the concentration sensor 15. As the current storage unit 19, for example, a secondary battery such as a LIB is used. Charging of the LIB 19 or supply of power to the load 18 is controlled by the correction unit 16.

On the basis of the methanol concentration determined from the output value of the sensor 15 and corrected by the correction unit 16, a concentration adjusting unit 20 controls the concentrated fuel pump 6, and adjusts the methanol concentration of the diluted fuel in the circulating route. The correction unit 16 corrects the output value of the concentration sensor 15 using the corrected relation between the output value of the concentration sensor 15 and the methanol concentration, and outputs the corrected value to the concentration adjusting unit 20. The concentration adjusting unit 20 adjusts on the basis of the corrected output from the concentration sensor 15.

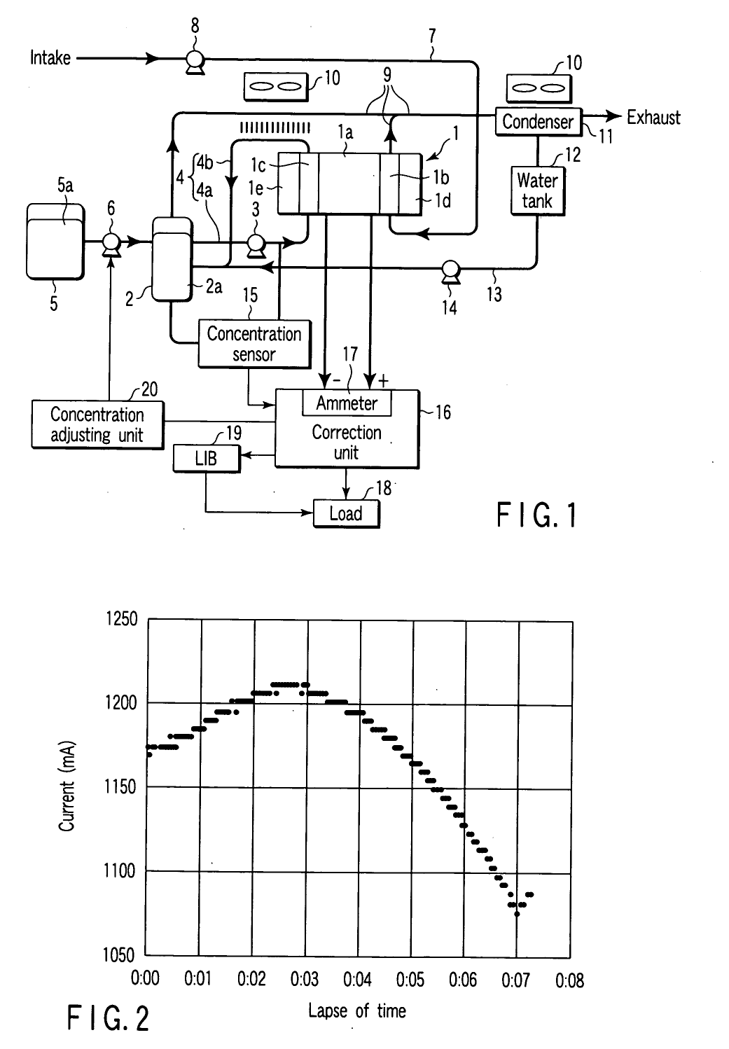

FIG. 2 is a graph showing the principle of correction between the concentration sensor 15 and the methanol concentration of the diluted fuel in the fuel cell system according to the first embodiment of the invention.

FIG. 2 shows an example of transition of the current flowing between the cathode 1b and the anode 1c in a state in which the concentrated fuel pump 6 is stopped. In this period, the conditions other than the methanol concentration of the circulating fuel, such as a kind of the load 18, a flow rate of a circulating fuel flowing in the fuel cell 1, and temperatures of the fuel cell 1 and the circulating fuel are controlled substantially constant. The concentration of the circulating fuel is lowered by the amount of consumption in the fuel cell 1 along with the time, and the figure is a plotting of the current value of the electric power generated by the fuel cell 1 at that concentration.

As shown in FIG. 2, along with lapse of time, that is, along with decline of the methanol concentration, the current once increasing and reaching the peak begins to drop along with decline of the methanol concentration. The relation between the methanol concentration and the current value shows a similar tendency when other operating conditions are same even if the capacity of the catalyst is lowered due to long-term use of the fuel cell 1, and the methanol concentration when the current value reaches the peak is not changed. By making use of this characteristic of the fuel cell 1, the correction unit 16 corrects the relation between the output value from the concentration sensor 15 and the methanol concentration of the diluted fuel determined from the output value of the concentration sensor 15.

To make constant the methanol concentration when the current value reaches the peak, it is desired to satisfy two points, (1) the stack temperature, or temperature at a fuel inlet of the passage plate is made to be constant, and (2) the stack voltage is kept constant. Incidentally, the stack is a laminated body comprising the membrane electrode assembly and the passage plate. Condition (1) can be achieved by maintaining constant the temperature of the diluted fuel 2a in the circulating fuel tank 2.

### Second Embodiment

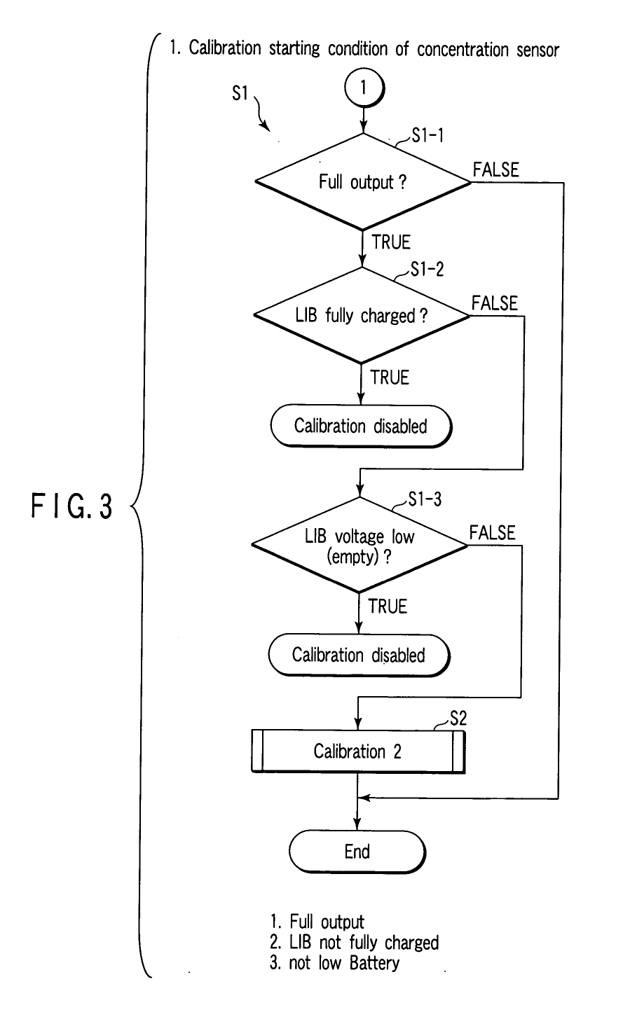

A method of operating a fuel cell system according to a second embodiment of the invention is shown in FIGS. 3 to 6.

FIG. 3 shows a preparatory operation prior to correction executed by the fuel cell system. The preparatory operation is intended to prevent complete discharge of the LIB 19 during correction. Another purpose is to prevent full charge of the LIB 19 during correction if the load is too small, and to prevent an output voltage of the fuel cell 1 from lowering than a limit voltage described below.

First, in step S1-1, the correction unit 16 confirms whether or not the fuel cell 1 can generate power at full output. If the fuel cell 1 cannot generate power at full output, the LIB 19 may be fully charged, the load may be zero, or the fuel cell system may be abnormal. In such a case, the correction unit 16 determines that correction cannot be executed, and preparation for correction is terminated.

In step S1-2, the correction unit 16 checks the charged state of the LIB 19. The correction unit 16 confirms whether or not the LIB 19 has a sufficient uncharged capacity so as not to reach fully charged during correction by the correction unit 16. If there is not uncharged capacity, the correction unit 16 determines that correction cannot be executed. If a sufficient uncharged capacity is confirmed, the process goes to the next step.

Subsequently, in step S1-3, the correction unit 16 checks the charged state of the LIB 19. The correction unit 16 confirms whether or not the LIB 19 has a sufficient capacity so as not to be discharged fully during correction by the correction unit 16. If there is no capacity, the correction unit 16 determines that correction cannot be executed. If a sufficient capacity is confirmed, the process goes to the next step S2.

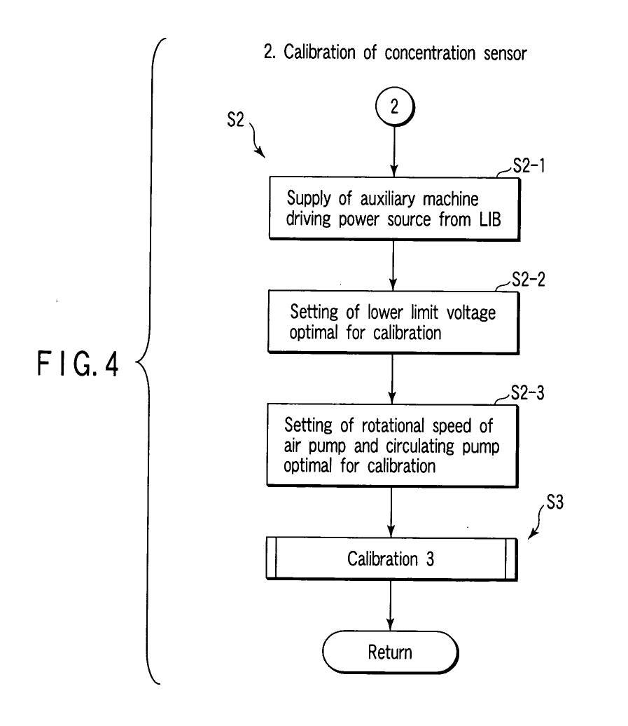

FIG. 4 is a flowchart showing an operation for adjusting the operating condition of the fuel cell 1 to a condition suited to correction prior to correction executed by the fuel cell system. The condition suited to correction is a preset operating condition of the fuel cell system.

In step S2-1, the correction unit 16 changes over a power source circuit so as to supply the electric power necessary for operation of the fuel cell system from the LIB 19 during correction. After changing over, therefore, the power necessary for operation of the fuel cell system such as the circulating pump 3, the concentration sensor 15 and the correction unit 16 is supplied from the LIB 19. The power source circuit is changed over in order to prevent the load of the fuel cell 1 from changing more than necessary because of the operating state of a correction unit.

Next, in step S2-2, the correction unit 16 sets the lower limit of a voltage of power generation of the fuel cell 1 during correction. This lower limit is a preset value. The preset lower limit is preferred to be set at a voltage of high power generation efficiency in consideration of the power generation capacity of the fuel cell 1.

Subsequently, in step S2-3, the correction unit 16 sets the rotating speed, that is, the flow rate of the circulating pump 3 and the air pump 8. The flow rate is preferred to be set at a value obtained by adding margin considering a pressure loss of the piping 4 or piping 7 to the flow rate assumed to be necessary for maintaining the output voltage of the fuel cell 1 at a higher than the lower limit voltage set in step S2-2. After setting of the flow rate of the circulating pump 3 and the air pump 8 is completed, the correction unit 16 advances to step S3.

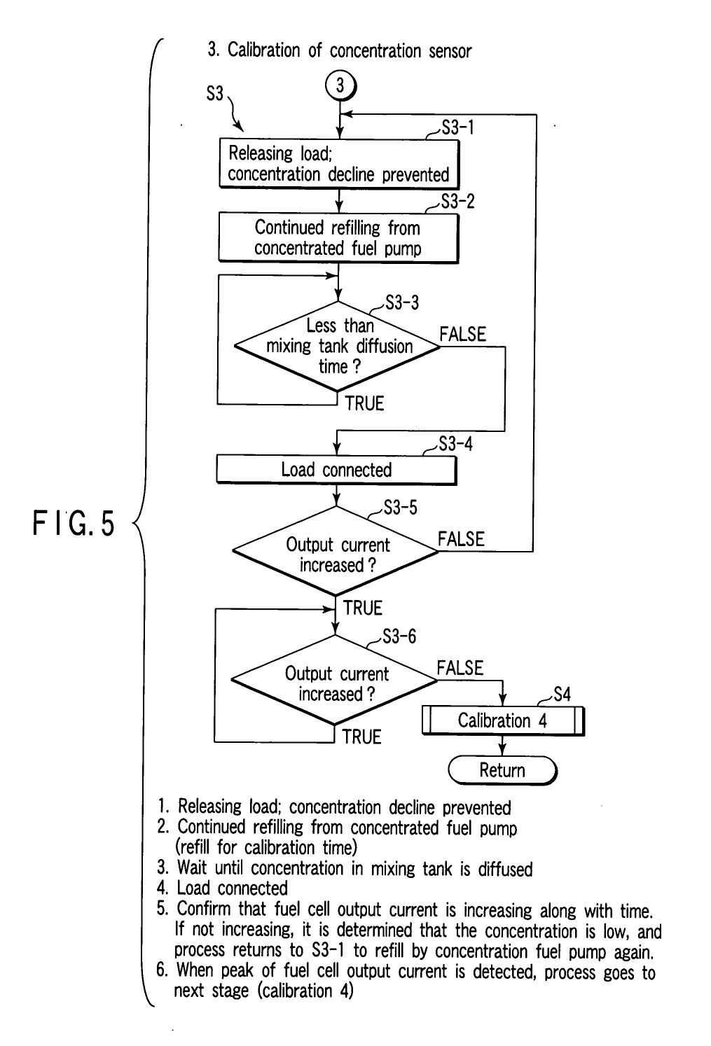

FIG. 5 shows an operation for detecting the peak point of the current value when the fuel cell 1 generates power in a state in which the concentrated fuel pump 6 is stopped.

In order to prevent decline of the methanol concentration of the diluted fuel in the circulating route, the power source circuit is changed over so as to supply the electric power to the load 18 from the LIB 19 in step S3-1. At the same time, charging of the LIB 19 from the fuel cell 1 is stopped.

To raise the methanol concentration of the diluted fuel in the circulating route, the correction unit 16, in step S3-2, drives the concentrated fuel pump 6 and adds the concentrated fuel to the diluted fuel in the circulating fuel tank (mixing tank) in the circulating route. Operation of the concentrated fuel pump 6 is continued for a preset time, and then is stopped.

Subsequently, in step S3-3, the correction unit 16 waits until the added concentrated fuel uniformly diffuses throughout the diluted fuel in the circulating route. Specifically, until the preset time passes, the correction unit 16 waits for connection from the fuel cell 1 to the load 18 or LIB 19.

In step S3-4, the correction unit 16 connects the load 18 or LIB 19 or both the load 18 and LIB 19 to the fuel cell 1 such that the fuel cell 1 generates power. At this time, the correction unit 16 distributes the electric power generated by the fuel cell 1 to the load 18 and LIB 19 such that the voltage of power generation of the fuel cell 1 is not lower than the lower limit set in step S2-2.

Thereafter, in steps S3-5 and S3-6, the ammeter 17 provided in the correction unit 16 measures the current flowing between the cathode 1b and the anode 1c. In step S3-5, the correction unit 16 determines whether or not the change amount of the measured current is in increasing tendency, and if it is in decreasing tendency, the process returns to step S3-1 in order to add the concentrated fuel again.

When the change amount of the measured current is in increasing tendency, the ammeter 17 continues to measure the current flowing between the cathode 1b and the anode 1c in step S3-6. On the basis of the measured current value, the correction unit 16 determines the change amount of current. The ammeter 17 continues to measure until the correction unit 16 determines that the change amount of the current is changed to decreasing tendency; and when determining to be changed to decreasing tendency, the correction unit 16 advances to step S4.

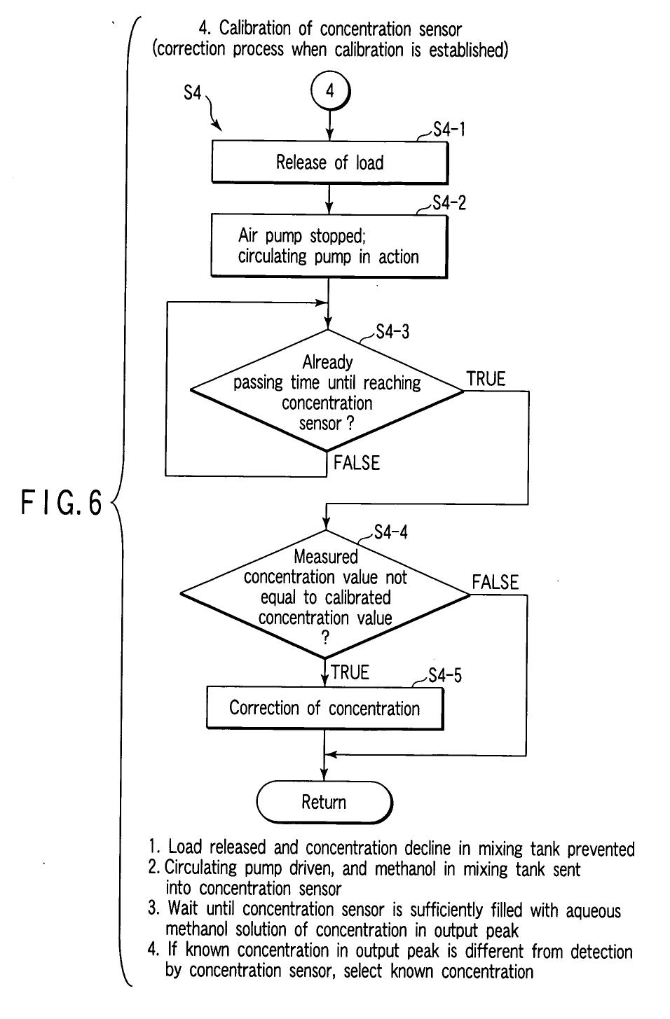

Referring to FIG. 6, an operation executed by the correction unit 16, for correcting the relation between the output value of the concentration sensor 15 and the methanol concentration will be explained.

In step S4-1, the correction unit 16 determines that the current flowing between the cathode 1b and the anode 1c is changed to decreasing tendency, and then, immediately stops supply of an electric power from the fuel cell 1 to the load 18 and LIB 19. This is intended to prevent the methanol concentration of the diluted fuel in the circulating route from dropping due to power generation of the fuel cell 1.

Next, in step S4-2, the correction unit 16 immediately stops the air feed pump 8. If the air feed pump 8 continues to operate, methanol in the diluted fuel passes through the polymer electrolyte membrane 1a and reacts with oxygen by the action of the catalyst provided in the cathode 1b, and this phenomenon (cross-over phenomenon) is accelerated, so that the methanol concentration of the diluted fuel in the circulating route is lowered. When the air feed pump 8 is stopped, the methanol concentration of the diluted fuel in the circulating route is low immediately after discharge from the anode 1c, and is close to the methanol concentration when the current flowing between the cathode 1b and the anode 1c is changed to decreasing tendency. Therefore, the correction unit 16 continues to operate the circulating pump 3 for a preset time described below.

In step S4-3, the correction unit 16 waits until the diluted fuel immediately after discharge from the anode 1c reaches the concentration sensor 15 and the concentration sensor 15 is filled with (replaced by) the diluted fuel immediately after discharge from the anode 1c. This waiting time may be determined in advance.

In step S4-4, the correction unit 16 compares an output value of the concentration sensor 15 after waiting in step S4-3 (corresponding to a first methanol concentration) and an output value of the concentration sensor 15 stored in the correction unit 16 (corresponding to a reference methanol concentration). The output value of the concentration sensor 15 corresponding to the reference methanol concentration is the output value of the concentration sensor 15 that is calculated from the data under the operating condition for obtaining the first methanol concentration at which the current flowing between the cathode 1b and the anode 1c becomes maximum. As a result of comparison, if the difference of the two is not larger than the allowable value in design of the fuel cell system, the correction unit 16 determines that correction is not necessary, and terminates the correction operation.

On the other hand, if the difference of the two is larger than the allowable value in design of the fuel cell system as a result of comparison, the correction unit 16 corrects the data of the relation between the output value of the concentration sensor 15 and the methanol concentration, and the data of the relation is stored in the correction unit 16. Specifically, the correction unit 16 does not rewrite the stored data, but is preferred to rewrite the stored coefficient, and to correct the stored data on the basis of the rewrote coefficient when the correction unit 16 reads out the stored data.

In the fuel cell system thus composed, the output value of the concentration sensor 15 is corrected by the correction unit 16 even if the ambient environment such as a fuel temperature is changed, or even if power generation by the fuel cell 1 is changed. Consequently, the methanol concentration of the fuel can be measured more accurately, and the methanol concentration of the diluted fuel can be adjusted more accurately.

Even when the fuel cell system is used for a long period, or even when the zero point adjustment of the concentration sensor is deviated gradually, the output value of the concentration sensor 15 can be corrected by the correction unit 16. Accordingly, the methanol concentration of the fuel can be measured more correctly, and the methanol concentration of the diluted fuel can be adjusted more accurately.

### EXAMPLES

In carbon black carrying platinum (Pt) fine particles as a catalyst for the cathode 1b, a perfluorocarbon sulfonic acid solution and ion exchange water were added, a carbon black carrying a catalyst was dispersed, and a paste was prepared. Carbon paper with water repellent treatment was prepared as a current collector of the cathode 1b, the paste was applied on the carbon paper and dried, and a catalyst layer was formed to obtain the cathode 1b.

In a carbon black carrying platinum-ruthenium (Pt:Ru=1:1) fine particles as a catalyst for the anode 1c, a perfluorocarbon sulfonic acid solution and ion exchange water were added, the carbon black carrying a catalyst was dispersed, and a paste was prepared. A carbon paper with water repellent treatment was prepared as a current collector of the anode 1c, the paste was applied to the carbon paper and dried, and a catalyst layer was formed to obtain the anode 1c.

A perfluorocarbon sulfonic acid film was arranged as the polymer electrolyte membrane 1a, the polymer electrolyte membrane 1a, the cathode 1b and the anode 1c were joined by hot pressing, and a membrane electrode assembly was obtained.

The membrane electrode assembly was enclosed by a carbon separator having passages for the cathode 1b and anode 1c formed therein, and a plurality of assemblies were laminated to obtain the fuel cell 1.

In a fuel cell system unstable in output, the fuel cell system and its operating method according to the first and second embodiments of the invention were applied, and the sensor was calibrated.

When the fuel cell 1 generated power at a substantially constant voltage of 11.3 V, and electric power was supplied to the load 18 and LIB 19, a peak current was observed at an output current of 1121 mA. When the diluted fuel recording this peak current was supplied into the concentration sensor 15, 1.1 mol/L was displayed. In the fuel cell 1 investigated initially, the concentration showing the peak current was 0.9 mol/L.

Therefore, by setting the coefficient −0.2 mol/L in the correction unit 16, it was corrected such that the sum of the output value of the concentration sensor 15 and the coefficient −0.2 mol/L was the methanol concentration of the diluted fuel.

After this correction, the fuel cell system continued to generate power stably.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A fuel cell system comprising:
a polymer electrolyte membrane;
a cathode provided at one side of the polymer electrolyte membrane;
an anode provided at the other side of the polymer electrolyte membrane;
an oxygen supply unit configured to supply oxygen to the cathode;
a fuel supply unit configured to supply a fuel containing methanol and water to the anode;
a methanol supply unit configured to supply methanol to the fuel;
a sensor which measures a methanol concentration of the fuel;
a current measuring unit configured to measure a current flowing between the cathode and the anode;
a concentration adjusting unit configured to adjust the methanol concentration of the fuel by controlling the methanol supply unit by using an output value of the sensor; and
a correction unit configured to correct a data of a relation between the methanol concentration of the fuel and the output value of the sensor, using an output of the current measuring unit.

2. The fuel cell system according to claim 1, wherein the correction unit corrects the data using the output of the current measuring unit when the methanol supply unit and the concentration adjusting unit are stopped.

3. The fuel cell system according to claim 2, further comprising a current storage unit configured to store the current and serve as a power supply source for the correction unit.

4. The fuel cell system according to claim 3,
wherein the current storage unit comprises a secondary battery.

5. The fuel cell system according to claim 2,
wherein the correction unit comprises a database having recorded therein a reference methanol concentration of the fuel when a value of the current measured by the current measuring unit is the maximum, and
the correction unit calculates a difference between a first methanol concentration of the fuel and the reference methanol concentration of the fuel, the first methanol concentration of the fuel measured by the sensor when the value of the current measured by the current measuring unit is the maximum while the methanol supply unit and the concentration adjusting unit remain stopped, and the correction unit corrects the data to reduce the difference.

6. The fuel cell system according to claim 5,
wherein the correction unit corrects the data to reduce the difference, when the difference is larger than a preset value.

7. The fuel cell system according to claim 5,
wherein the fuel supply unit comprises a tank in which the fuel is stored, and
the first methanol concentration of the fuel is measured by the sensor when the value of the current measured by the current measuring unit is the maximum under the condition in which the methanol supply unit and the concentration adjusting unit remain stopped, and a voltage between the cathode and the anode and a temperature of the fuel in the tank are maintained at constant values.

8. The fuel cell system according to claim 1,
wherein the sensor is an ultrasonic oscillator sensor.

9. A method of operating a fuel cell system comprising:
a polymer electrolyte membrane;
a cathode provided at one side of the polymer electrolyte membrane;
an anode provided at the other side of the polymer electrolyte membrane;
an oxygen supply unit configured to supply oxygen to the cathode;
a fuel supply unit configured to supply a fuel containing methanol and water to the anode;
a methanol supply unit configured to supply methanol to the fuel;
a sensor which measures a methanol concentration of the fuel;
a current measuring unit configured to measure a current flowing between the cathode and the anode; and
a concentration adjusting unit configured to adjust the methanol concentration of the fuel by controlling the methanol supply unit by using an output value of the sensor, the method comprising:
stopping both the methanol supply unit and the concentration adjusting unit; and
correcting a data of a relation between the methanol concentration of the fuel and the output value of the sensor, using an output of the current measuring unit.

10. The method of operating a fuel cell system, according to claim 9, further comprising:
obtaining, after the stopping, a first methanol concentration of the fuel measured by the sensor when a value of the current measured by the current measuring unit is the maximum; and
calculating a difference between the first methanol concentration of the fuel and a reference methanol concentration of the fuel when the value of the current measured by the current measuring unit is the maximum; and
correcting the data to reduce the difference.

11. The method of operating a fuel cell system, according to claim 10,
wherein the data is corrected to reduce the difference when the difference is larger than a preset value.

12. The method of operating a fuel cell system, according to claim 10,
wherein the fuel supply unit comprises a tank in which the fuel is stored, and
the first methanol concentration of the fuel is measured by the sensor when the value of the current measured by the current measuring unit is the maximum under the condition in which the methanol supply unit and the concentration adjusting unit remain stopped, and a voltage between the cathode and the anode and a temperature of the fuel in the tank are maintained at constant values.

13. The method of operating a fuel cell system, according to claim 9, further comprising:
adjusting, before the stopping, the methanol concentration of the fuel to become higher by the concentration adjusting unit.

14. The method of operating a fuel cell system, according to claim 9,
wherein the fuel cell system further comprises a current storage unit configured to store the current and serve as a power supply source during the correcting.

15. The method of operating a fuel cell system, according to claim 14, wherein the current storage unit comprises a secondary battery.

16. The method of operating a fuel cell system, according to claim 9,
wherein the sensor is an ultrasonic oscillator sensor.
